(19) United States
(12) Patent Application Publication
(10) Pub. No.: US 2022/0306148 A1
(43) Pub. Date: Sep. 29, 2022

(54) Method and Apparatus Applied in Autonomous Vehicle

(71) Applicant: Bayerische Motoren Werke Aktiengesellschaft, Muenchen (DE)

(72) Inventors: Christoph GOESSELSBERGER, Beijing (CN); Keith YOUNG, Beijing (CN)

(21) Appl. No.: 17/596,911

(22) PCT Filed: Jul. 8, 2019
(86) PCT No.: PCT/CN2019/095074

§ 371 Date: Dec. 21, 2021

(51) Int. Cl. B60W 60/00; B60W 40/02; B60W 10/18; B60W 10/20; B60W 40/09; B60W 50/00; B60W 50/14; B60W 50/02

(52) U.S. Cl. CPC B60W 60/001; B60W 40/02; B60W 10/18; B60W 10/20; B60W 40/09; B60W 50/0097; B60W 50/14; B60W 50/0205; B60W 2540/30; B60W 2420/52; B60W 2420/42; B60W 2420/54; B60W 2520/00; B60W 2050/146

(57) ABSTRACT

A method (200) and an apparatus (100) applied in autonomous vehicle. The method (200) applied in an autonomous vehicle comprises: receiving data from a plurality of environment perception sensors on the vehicle and data from a plurality of vehicle motion sensors on the vehicle; generating control parameters for control devices including an acceleration device, a braking device, and a steering device, based on at least the received data; and outputting the received data and the generated control parameters to the driver.

### FIELD OF THE INVENTION

The present disclosure relates in general to a method and apparatus applied in an autonomous vehicle.

### BACKGROUND OF THE INVENTION

Autonomous vehicles, also called pilotless vehicles, which have the fully autonomous driving function, have developed rapidly in recent years. It is expected that the autonomous vehicles will provide better safety and a better driving experience. It is also expected that the autonomous vehicles with fully autonomous driving function will be put into practical use in years to come.

For young drivers (i.e., the drivers with relatively less driving experience), they desire to learn how to drive and to improve their driving skill.

### SUMMARY OF THE INVENTION

The present disclosure aims to provide a method and apparatus applied in an autonomous vehicle, which is capable of facilitating the young drivers to drive.

In accordance with some exemplary embodiments of the present disclosure, a method applied in an autonomous vehicle is provided, characterized in comprising: receiving data from a plurality of environment perception sensors on the vehicle and data from a plurality of vehicle motion sensors on the vehicle, generating control parameters for control devices including an acceleration device, a braking device, and a steering device, based on at least the received data, and outputting the received data and the generated control parameters to the driver.

In some embodiments, generating the control parameters may comprise: generating the control parameters with use of a machine learning technology, based on the received data and map information.

In some embodiments, the control parameters may comprise: an acceleration starting time, an acceleration ending time, and an acceleration for the acceleration device; a braking starting time, a braking ending time, and an acceleration for the braking device; and a steering starting time, a steering ending time, and a steering angle for the steering device.

In some embodiments, the method may further comprise: receiving data from a plurality of position sensors mounted in the control devices, in a case wherein the driver manually drives the vehicle; comparing the data from the plurality of position sensors with the corresponding control parameters, so as to generate evaluation for the driver's driving skill; and outputting the evaluation for the driver's driving skill.

In some embodiments, the method may further comprise: receiving data from a plurality of position sensors mounted in the control devices, in a case wherein the driver manually drives the vehicle, comparing the data from the plurality of position sensors with the corresponding control parameters, so as to generate suggestions for improving the driver's driving skill, and outputting the suggestions for improving the driver's driving skill.

In some embodiments, the method may further comprise: receiving data from a plurality of position sensors mounted in the control devices, in a case wherein the driver manually drives the vehicle; predicting an upcoming driving situation, based on the data from the plurality of position sensors, the data from the plurality of environment perception sensors, and the data from the plurality of vehicle motion sensors; and if it is predicted that there is a danger, outputting a warning to the driver, or intervening the driving.

In some embodiments, the method may further comprise: receiving data from a plurality of driver-monitoring sensors on the vehicle, in a case wherein the driver manually drives the vehicle; determining whether there is an abnormality, based on the data from the plurality of driver-monitoring sensors; and if it is determined that there is an abnormality, outputting a warning to the driver, or intervening the driving.

In accordance with some other exemplary embodiments of the present disclosure, an apparatus applied in an autonomous vehicle is provided.

In accordance with still some other exemplary embodiments of the present disclosure, a system applied in an autonomous vehicle is provided.

In accordance with still some other exemplary embodiments of the present disclosure, a non-transitory computer readable medium and an autonomous vehicle are provided.

Further scope of the applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from the following detailed description.

### BRIEF DESCRIPTION OF THE DRAWINGS

The accompanying drawings, which are incorporated in and constitute a part of the specification, illustrate embodiments of the present disclosure and, together with the description, serve to explain the principles of the disclosure, without limitation. In the figures, similar reference numerals are used for denoting similar items. The figures, which are not necessarily to scale, depict selected illustrative embodiments and are not intended to limit the scope of the disclosure.

FIG. 1 is a block diagram of an exemplary apparatus applied in an autonomous vehicle in accordance with some embodiments of the present disclosure.

FIG. 2 is a flowchart illustrating an exemplary method applied in an autonomous vehicle in accordance with some embodiments of the present disclosure.

FIG. 3 is a block diagram of another exemplary apparatus applied in an autonomous vehicle in accordance with some embodiments of the present disclosure.

FIG. 4 is a flowchart illustrating another exemplary method applied in an autonomous vehicle in accordance with some embodiments of the present disclosure.

FIG. 5 is a flowchart illustrating an exemplary warning method applied in an autonomous vehicle in accordance with some embodiments of the present disclosure.

FIG. 6 is a flowchart illustrating another exemplary warning method applied in an autonomous vehicle in accordance with some embodiments of the present disclosure.

FIG. 7 illustrates a general hardware environment wherein the present disclosure is applicable in accordance with some exemplary embodiments of the present disclosure.

### DETAILED DESCRIPTION OF THE PREFERRED EMBODIMENTS

In the following detailed description, numerous specific details are set forth to provide a thorough understanding of the described exemplary embodiments. It will be apparent, however, to one skilled in the art that the described embodiments can be practiced without some or all of these specific details. In the described exemplary embodiments, well known structures or process steps have not been described in detail in order to avoid unnecessarily obscuring the concept of the present disclosure.

The blocks within each of the block diagrams shown hereinafter may be implemented by hardware, software, firmware, or any combination thereof to carry out the principles of the present disclosure. It is understood by those skilled in the art that the blocks described in each of the block diagrams may be combined or separated into sub-blocks to implement the principles of the present disclosure.

The steps of the method presented in the present disclosure are intended to be illustrative. In some embodiments, the method may be accomplished with one or more additional steps not described, and/or without one or more of the steps discussed. Additionally, the order in which the steps of method are illustrated and described is not intended to be limiting.

The term “vehicle” used through the specification refers to a motor vehicle which comprises but is not limited to a car, a truck, a bus, or the like. The term “A or B” used through the specification refers to “A and B” and “A or B” rather than meaning that A and B are exclusive, unless otherwise specified.

The term “autonomous vehicle” used through the specification refers to the vehicle that has the fully autonomous driving function. And, in the present disclosure, the driver, who is the outputting object, refers to young drivers or drivers with relatively less driving experience.

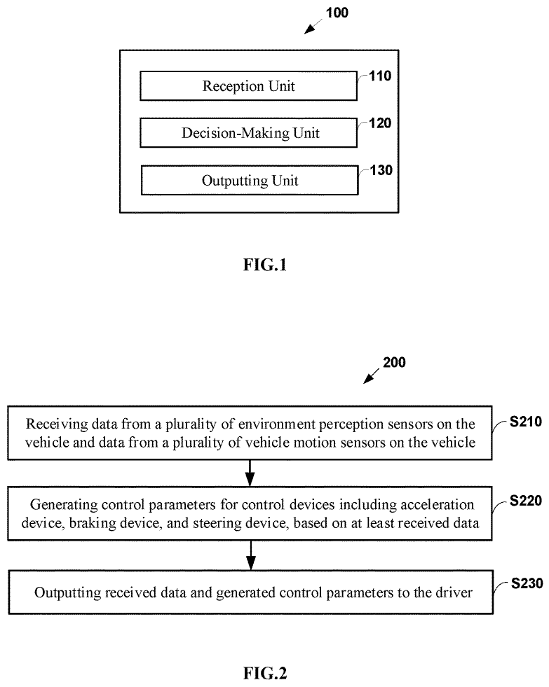

FIG. 1 is a block diagram of an exemplary apparatus 100 applied in an autonomous vehicle in accordance with some embodiments of the present disclosure.

As shown in FIG. 1, the apparatus 100 (or a driving assistance apparatus) may comprise a reception unit 110 configured to receive data from a plurality of environment perception sensors on the vehicle and data from a plurality of vehicle motion sensors on the vehicle; a decision-making unit 120 configured to generate control parameters for control devices including an acceleration device, a braking device, and a steering device, based on at least the received data; and an outputting unit 130 configured to output the received data and the generated control parameters to the driver.

FIG. 2 is a flowchart illustrating an exemplary method 200 applied in an autonomous vehicle in accordance with some embodiments of the present disclosure. The method 200 (or a driving assistance method) may comprise: a step S210 of receiving data from a plurality of environment perception sensors on the vehicle and data from a plurality of vehicle motion sensors on the vehicle; a step S220 of generating control parameters for control devices including an acceleration device, a braking device, and a steering device, based on at least the received data; and a step S230 of outputting the received data and the generated control parameters to the driver.

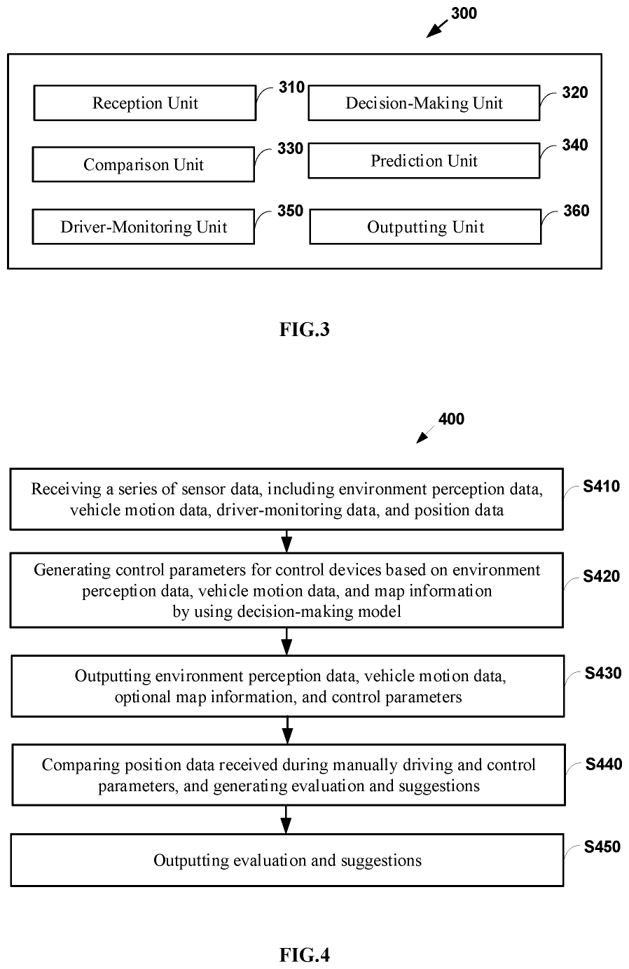

Next, some exemplary embodiments of the present disclosure will be described with reference to FIG. 3-FIG. 6.

FIG. 3 shows a block diagram of another exemplary apparatus 300 applied in an autonomous vehicle in accordance with some embodiments of the present disclosure.

As shown in FIG. 3, the apparatus 300 may comprise a reception unit 310, a decision-making unit 320, a comparison unit 330, a prediction unit 340, a driver-monitoring unit 350, and an outputting unit 360.

The reception unit 310 receives data (referred to as the environment perception data hereinafter) from a plurality of environment perception sensors on the vehicle, data (referred to as the vehicle motion data hereinafter) from a plurality of vehicle motion sensors on the vehicle, data (referred to as the driver-monitoring data hereinafter) from a plurality of driver-monitoring sensors on the vehicle, and data (referred to as the position data hereinafter) from a plurality of position sensors mounted in the control devices of the vehicle.

The environment perception sensors may comprise at least one of the following: a laser radar, a millimeter wave radar, a camera, and an ultrasonic sensor. The environment perception data may reflect the position, the orientation, the speed, and the like of the surrounding objects, such as a vehicle, a bicycle, a pedestrian, trees, buildings, or the like. The vehicle motion sensors may comprise at least one of the following: a speed sensor, an angular velocity sensor, an inertial sensor, and a global positioning system. The vehicle motion data may reflect the position, the orientation, the speed, and the like of the vehicle per se. The driver-monitoring sensors may comprise at least one of the following: a camera, and a bioelectric sensor. The driver-monitoring data may reflect the state of the driver, for example, whether he is sleepy, nervous, or the like, and may reflect where he is staring. The driver-monitoring data may also reflect the health status of the driver.

The control devices may comprise an acceleration device such as a throttle, a braking device such as a brake, and a steering device such as a steering wheel. The position sensors mounted in the control devices are those known to those skilled in the art. In a case wherein the driver manually drives the vehicle, the position data may reflect the manipulation amount on a corresponding control device. For example, the position data from the position sensor mounted in the steering wheel may reflect the angle at which the steering wheel is turned around by the driver. The position data may comprise the time information indicating the corresponding manipulation times. The “manually driving” here refers to fully manually driving or semi-manually driving (i.e., semi-autonomous driving).

The decision-making unit 320 generates the control parameters for the control devices, based on at least the environment perception data and the vehicle motion data. Specifically, the decision-making unit 320 generates the control parameters based on the environment perception data, the vehicle motion data, and the map information by using a machine learning technology. The map information may be a piece of high definition map and may be pre-stored in a storage (not illustrated) on the vehicle. The map information may indicate lane lines, intersections, speed limits, and the like. The machine learning technology may be any kind of known machine learning technology. Moreover, the decision-making unit 320 transmits the generated control parameters to the corresponding control devices for achieving the control of the vehicle.

Specifically, the machine learning technology uses a knowledge base of expert experience to train a decision-making model, and then uses the trained decision-making model to make decisions. The made decisions may comprise the planed travelling path and/or the specific control parameters. Here, the expert experience refers to experienced drivers' experience. The knowledge base of expert experience may contain the manipulation parameters collected from a huge number of experienced drivers, such as the drivers with more than 5 driving years. The manipulation parameters may comprise the manipulation amounts and the manipulation times on the control devices.

More specifically, in the training phase, the machine learning technology uses the environment perception data, the vehicle motion data, and the map information as the inputs and uses the corresponding manipulation parameters from knowledge base of expert experience as the output to train the decision-making model. And then in the decision-making phase, the machine learning technology uses the trained decision-making model to generate the control parameters with the environment perception data, the vehicle motion data, and the map information used as the inputs. That is, during the fully autonomous driving of the autonomous vehicle, the generated control parameters reflect the experienced drivers' manipulation behaviors.

The comparison unit 330 compares the position data received during the driver manually drives the vehicle with the corresponding control parameters, so as to generate evaluation for the driver's driving skill and suggestions for improving the driver's driving skill. The operations of the comparison unit 330 will be described in detail later.

The prediction unit 340 predicts an upcoming driving situation, based on the position data received during the driver manually drives the vehicle, the environment perception data, and the vehicle motion data. More specifically, the prediction unit 340 performs the prediction based on such sensor data and the map information with use of the pre-stored algorithm(s). Any prediction algorithms known to those skilled in the art may be used here.

The driver-monitoring unit 350 determines whether there is an abnormality as to the driver based on the driver-monitoring data. Specifically, the driver-monitoring unit 350 makes the determination by analyzing the driver-monitoring data. Various analysis algorithms known to those skilled in the art may be used here.

The operations of the prediction unit 340 and the driver-monitoring unit 350 will be described in detail later.

The outputting unit 360 outputs the environment perception data, the vehicle motion data, and the generated control parameters to the driver, so as to teach the driver how to drive. In other words, the outputting unit 360 presents the decision-making process to the driver, such that the driver may learn the driving experience from experienced drivers. The outputting unit 360 may further output the map information in combination with the above-mentioned items. Further, the outputting unit 360 may output the evaluation and the suggestions as to the driver's driving skill. Furthermore, the outputting unit 360 may output warnings when necessary.

The operations of each unit as shown in FIG. 3 will be further described in detail hereinafter.

FIG. 4 is a flowchart illustrating another exemplary method 400 applied in an autonomous vehicle in accordance with some embodiments of the present disclosure.

The method 400 starts from step S410, at which the reception unit 310 receives a series of sensor data, including the environment perception data, the vehicle motion data, the driver-monitoring data, and the position data. The reception unit 310 delivers the series of sensor data to the decision-making unit 320.

The method 400 proceeds to step S420, at which the decision-making unit 320 generates the control parameters for the control devices based on the environment perception data, the vehicle motion data, and the map information by using the decision-making model trained with use of the knowledge base of expert experience.

The control parameters may comprise the manipulation times and the manipulation amounts for the control devices. For example, for the acceleration device, the control parameters may comprise the acceleration starting and ending times and the acceleration. For the braking device, the control parameters may comprise the braking starting and ending times and the acceleration. And for the steering device, the control parameters may comprise the steering starting and ending times and the steering angle.

The method 400 proceeds to step S430, at which the outputting unit 360 outputs the environment perception data, the vehicle motion data, the optional map information, and the control parameters to the driver, such that the driver may learn how to drive.

The above items may be output to a display and/or a speaker within the vehicle or to a mobile communication device of the driver. The mobile communication device may comprise a smart phone, a tablet PC, or the like. Specifically, the above items may be output to an app provided in the mobile communication device of the driver. The outputting may be achieved via a human-machine-interface (HMI).

In some embodiments, the above items may be output in a visual manner. For example, the outputting unit 360 may, as the vehicle moves, dynamically display the map image, on which the images of the surrounding objects such as close-by vehicles and pedestrians (that is, the image form of the environment perception data), the image of the vehicle per se (that is, the image form of the vehicle motion data), and the control parameters, such as when to accelerate, brake, or steer and at which level to perform acceleration, braking, and steering, are also dynamically displayed.

Alternatively, the above items may be output in an acoustic manner. For example, the outputting unit 360 may output voice instructions that correspond to the control parameters. Specifically, the outputting unit 360 may output the following voice instructions: “Turning the steering wheel right now for 180 degrees”, “There is a pedestrian running from the right side, stepping down the brake quickly now”, or the like. In such a case, the outputting unit 360 may instruct the driver, with a voice, when to accelerate, brake, or steer and at which level to perform acceleration, braking, and steering, in a real-time way.

Please note that, the outputting unit 360 may perform the outputting in a fully autonomous driving state or a semi-autonomous driving state or a fully manually driving state for the vehicle.

In the case wherein the outputting unit 360 outputs the environment perception data, the vehicle motion data, the optional map information, and the control parameters, we may call it a teaching/instruction mode. Via such teaching/instruction mode, the driver may learn the driving rules and gather the driving experience.

The method 400 proceeds to step S440, at which the comparison unit 330 compares the position data received during the manually driving and the control parameters generated by the decision-making unit 320, and generates the evaluation and the suggestions for the driver.

During the manually driving, the control parameters may be generated but not be used for the control of the vehicle.

In some embodiments, the comparison unit 330 compares the driver's manipulation times and the manipulation amounts, reflected by the position data, with the corresponding control parameters. Based on the differences therebetween, the driver's driving skill may be evaluated into different ranks. As can be understood, the smaller the differences are, the higher the rank is. Given that there are five ranks, rank 1 to rank 5, with gradually decreasing evaluations, rank 1 and rank 2 may be deemed as that the driver has the ability of fully manually driving, while rank 3 to rank 5 may be deemed as that the driver does not have the ability of fully manually driving.

Specifically, the comparison unit 330 may generate a plurality of driving curves reflecting the variations of respective manipulation parameters as the time elapses, based on the position data received during the manually driving. Further, the comparison unit 330 may generate a plurality of control curves reflecting the variations of respective control parameters as the time elapses, based on the corresponding control parameters, in the same way. Then, the comparison unit 330 may calculate the similarities between the corresponding driving curves and control curves, so as to generate evaluation for the driver's driving skill. Based on the calculated similarities, the driver's driving skill may be evaluated into different ranks. As can be understood, the higher the similarities are, the higher the rank is.

In some embodiments, based on the comparison, the comparison unit 330 may further generate suggestions for improving the driver's driving skill. Specifically, the comparison unit 330 may find one or more parts of the driving curve which have certain differences with the corresponding control curve and generate suggestions with respect to such parts. For example, the examples of the suggestions may comprise: “you may apply less throttle during start for efficiency”, “you may use cruise control on highways”, “you may turn the steering wheel more when turning left”, and so on. In other words, the comparison unit 330 may find the differences between the driver's driving behaviors and the autonomous (i.e., mature) driving behaviors, and may point out where the driver may do better.

The method 400 proceeds to step S450, at which the outputting unit 360 outputs the evaluation and the suggestions generated in the step S440.

The outputting in the step S450 is similar to that in the step S430. The evaluation and the suggestions may be output after a predetermined period of driving. The evaluation and the suggestions may be output in a text or speech manner. The comparison between the driving data and the control data, especially the comparison between the driving curves and the control curves, may be output, e.g., in a graph, along with the evaluation and the suggestions, such that the driver may get known the basis for the evaluation and the suggestions.

Given that the evaluation and the suggestions are transmitted to the mobile communication device of the driver, the driver may review his driving behaviors after leaving the vehicle, which is advantageous for improving his driving skill.

In the case wherein the outputting unit 360 outputs the evaluation and the suggestions, we may call it an evaluation and suggestion mode. Via such evaluation and the suggestion mode, firstly, the apparatus is capable of evaluating the driver's driving skill, and secondly, the apparatus is capable of providing suggestions in a manner customized for the driver.

Please note that, in the steps S440 and S450, both the evaluation and the suggestions are generated and output. But as can be understood, the evaluation, the suggestions, or the both may be generated and output.

FIG. 5 is a flowchart illustrating an exemplary warning method applied in an autonomous vehicle in accordance with some embodiments of the present disclosure.

The method 500 starts from step S510, at which the reception unit 310 receives a series of sensor data. The step S510 is similar to the step S410 and thus the description thereof is omitted here.

The method 500 proceeds to step S520, at which the prediction unit 340 predicts an upcoming driving situation, based on the position data received during the manually driving, the environment perception data, the vehicle motion data, the planed travelling path, and the map information.

In some embodiments, the prediction unit 340 may predict an emergent situation. For example, if the environment perception data indicates that there is a pedestrian running toward the vehicle from the right side, and the prediction unit 340 predicts that this pedestrian will collide with the vehicle, then the prediction unit 340 predicts that there is a danger. For another example, when the vehicle is trying to change to an adjacent lane, and the environment perception data indicates that there is a posterior vehicle traveling with a high speed on the adjacent lane, the prediction unit 340 predicts that a collision will occur if the vehicle continues to change lane. Then the prediction unit 340 predicts that there is a danger.

In some embodiments, the prediction unit 340 may predict a certain driving task cannot be completed. For example, when the vehicle is turning left, if the driver turns around the steering wheel too late, the prediction unit 340 predicts that the vehicle cannot turn left successfully. Then the prediction unit 340 predicts that there is a danger.

The method 500 then proceeds to step S530, at which the decision-making unit 320 instructs the outputting unit 360 to output a warning, or the decision-making unit 320 decides to intervene the driving, if the danger is predicted in the step S520.

Given that the danger is predicted, for example, the warning is output via an animation, via a warning sound, and/or via the vibrating. A vibrating device may be provided within the vehicle or within the mobile communication device of the driver. Further, the decision-making unit 320 may control the control devices so as to intervene the driving. For example, the decision-making unit 320 may control the control devices to stop the vehicle immediately, to forbid the driver to change lane for a while, or to turn around the steering wheel more so as to complete the turning task. Alternatively, the decision-making unit 320 may decide to switch to the fully autonomous driving so as to take over all the privileges of the driver. That is, the decision-making unit 320 may intervene the driving in various means in order to avoid the occurrence of the danger or the incompletion of a certain task.

In the case wherein the prediction is performed and corresponding measure(s) are taken, we may call it a predication mode. Via such predication mode, the driving safety can be ensured. Further, the teaching/instruction mode and the evaluation and suggestion mode as mentioned above may be achieved while the driving safety can be ensured.

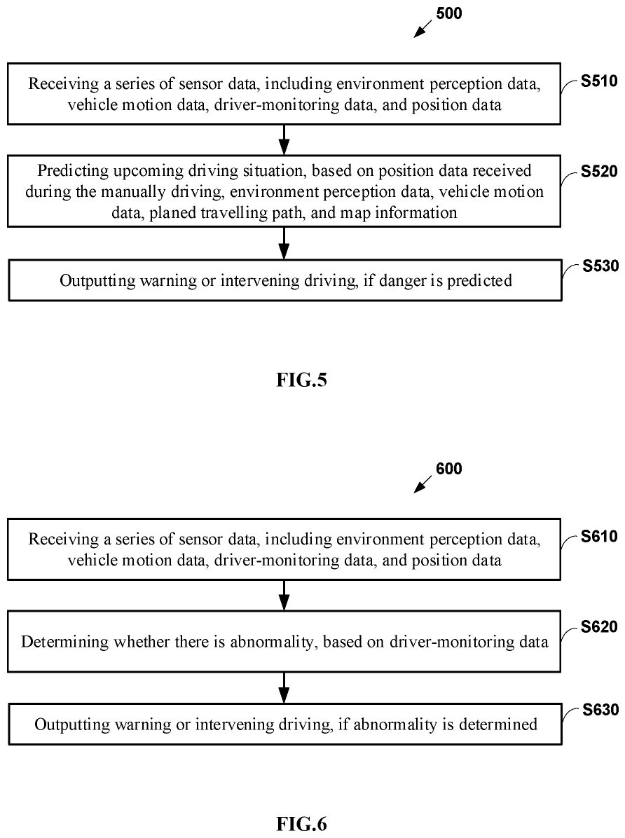

FIG. 6 is a flowchart illustrating another exemplary warning method applied in an autonomous vehicle in accordance with some embodiments of the present disclosure.

The method 600 starts from step S610, at which the reception unit 310 receives a series of sensor data. The step S610 is similar to the step S410 and thus the description thereof is omitted here.

The method 600 proceeds to step S620, at which the driver-monitoring unit 350 analyzes the received driver-monitoring data and determines whether there is an abnormality.

In some embodiments, the driver-monitoring unit 350 may determine whether the driver is sleepy or nervous based on the data from one or more cameras for taking the driver's pictures. Also, the driver-monitoring unit 350 may determine whether the driver has a sudden health problem based on the data from one or more bioelectric sensors which is contactable to the driver.

The method 600 then proceeds to step S630, at which the decision-making unit 320 instructs the outputting unit 360 to output a warning, or the decision-making unit 320 decides to intervene the driving if an abnormality is determined in the step S620. For example, the decision-making unit 320 may decide to take over all the privileges of the driver or to stop the vehicle if possible.

In the case wherein the driver is monitored and corresponding measure(s) are taken, we may call it a monitoring mode. Via such monitoring mode, the driving safety can be ensured. Further, the teaching/instruction mode and the evaluation and suggestion mode as mentioned above may be achieved while the driving safety can be ensured.

In some embodiments, the evaluation or the suggestions may be provided further based on the occurrence of the intervention. For example, if the times of the intervention during a predetermined time period is very low, e.g., zero, the evaluation may be provided that the driver has the ability of fully manual driving. For another example, if the interventions occur frequently, the reasons why the interventions occur may be summarized and output to the driver, and related suggestions may be output at the same time.

Further, in some embodiments, in response to the evaluation that the driver has the ability of fully manual driving, more or even all manual driving privileges may be open to the driver. For example, the top speed limit, the top power output limit, or the like may not be set any more.

At least one of the teaching/instruction mode, the evaluation and suggestion mode, the predication mode, and the monitoring mode, as mentioned-above may constitute a young driver mode. The young driver mode may be activated with a hardware or software button. Alternatively, the young driver mode may be activated with a user name and/or a password. Still alternatively, the young driver mode may be activated with a voice instruction. The young driver mode may well facilitate the driving of the young driver, meanwhile the driving safety may be ensured. Furthermore, such young driver mode enhances the human-machine interactions.

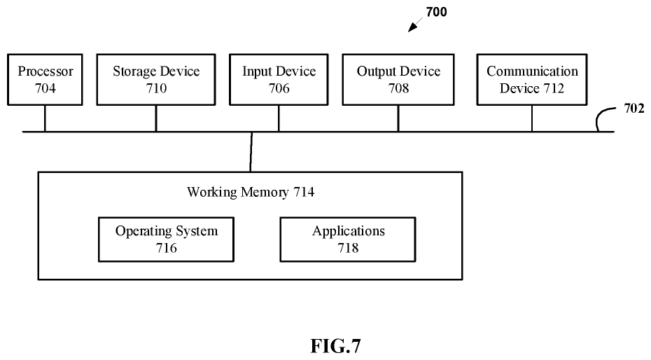

FIG. 7 illustrates a general hardware environment 700 wherein the present disclosure is applicable in accordance with some exemplary embodiments of the present disclosure.

With reference to FIG. 7, a computing device 700, which is an example of the hardware device that may be applied to the aspects of the present disclosure, will now be described. The computing device 700 may be any machine configured to perform processing and/or calculations, may be but is not limited to a work station, a server, a desktop computer, a laptop computer, a tablet computer, a personal data assistant, a smart phone, an on-vehicle computer or any combination thereof. The aforementioned apparatus 100 or 300 may be wholly or at least partially implemented by the computing device 700 or a similar device or system.

The computing device 700 may comprise elements that are connected with or in communication with a bus 702, possibly via one or more interfaces. For example, the computing device 700 may comprise the bus 702, and one or more processors 704, one or more input devices 706 and one or more output devices 708. The one or more processors 704 may be any kinds of processors, and may comprise but are not limited to one or more general-purpose processors and/or one or more special-purpose processors (such as special processing chips). The input devices 706 may be any kinds of devices that can input information to the computing device, and may comprise but are not limited to a mouse, a keyboard, a touch screen, a microphone and/or a remote control. The output devices 708 may be any kinds of devices that can present information, and may comprise but are not limited to display, a speaker, a video/audio output terminal, a vibrator and/or a printer. The computing device 700 may also comprise or be connected with non-transitory storage devices 710 which may be any storage devices that are non-transitory and can implement data stores, and may comprise but are not limited to a disk drive, an optical storage device, a solid-state storage, a floppy disk, a flexible disk, hard disk, a magnetic tape or any other magnetic medium, a compact disc or any other optical medium, a ROM (Read Only Memory), a RAM (Random Access Memory), a cache memory and/or any other memory chip or cartridge, and/or any other medium from which a computer may read data, instructions and/or code. The non-transitory storage devices 710 may be detachable from an interface. The non-transitory storage devices 710 may have data/instructions/code for implementing the methods and steps which are described above. The computing device 700 may also comprise a communication device 712. The communication device 712 may be any kinds of device or system that can enable communication with external apparatuses and/or with a network, and may comprise but are not limited to a modem, a network card, an infrared communication device, a wireless communication device and/or a chipset such as a Bluetooth™ device, 1302.11 device, WiFi device, WiMax device, cellular communication facilities and/or the like. The transceiver(s) 107 as aforementioned may, for example, be implemented by the communication device 712.

When the computing device 700 is used as an on-vehicle device, it may also be connected to external device, for example, a GPS receiver, sensors for sensing different environmental data such as an acceleration sensor, a wheel speed sensor, a gyroscope and so on. In this way, the computing device 700 may, for example, receive location data and sensor data indicating the travelling situation of the vehicle. When the computing device 700 is used as an on-vehicle device, it may also be connected to other facilities (such as an engine system, a wiper, an anti-lock Braking System or the like) for controlling the traveling and operation of the vehicle.

In addition, the non-transitory storage device 710 may have map information and software elements so that the processor 704 may perform route guidance processing. In addition, the output device 706 may comprise a display for displaying the map, the location mark of the vehicle and also images indicating the travelling situation of the vehicle. The output device 706 may also comprise a speaker or interface with an ear phone for audio guidance.

The bus 702 may include but is not limited to Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Particularly, for an on-vehicle device, the bus 702 may also include a Controller Area Network (CAN) bus or other architectures designed for application on an automobile.

The computing device 700 may also comprise a working memory 714, which may be any kind of working memory that may store instructions and/or data useful for the working of the processor 704, and may comprise but is not limited to a random access memory and/or a read-only memory device.

Software elements may be located in the working memory 714, including but are not limited to an operating system 716, one or more application programs 718, drivers and/or other data and codes. Instructions for performing the methods and steps described in the above may be comprised in the one or more application programs 718, and the modules of the aforementioned apparatus 100 or 300 may be implemented by the processor 704 reading and executing the instructions of the one or more application programs 718. More specifically, the reception unit 110 of the aforementioned apparatus 100 may, for example, be implemented by the processor 704 when executing an application 718 having instructions to perform the step 210. The decision-making unit 120 of the apparatus 100 may, for example, be implemented by the processor 704 when executing an application 718 having instructions to perform the step 220. And, the decision-making unit 130 of the apparatus 100 may, for example, be implemented by the processor 704 when executing an application 718 having instructions to perform the step 230. Similarly, the units of the aforementioned apparatus 300 may also, for example, be implemented by the processor 704 when executing an application 718 having instructions to perform one or more of the aforementioned respective steps. The executable codes or source codes of the instructions of the software elements may be stored in a non-transitory computer-readable storage medium, such as the storage device(s) 710 described above, and may be read into the working memory 714 possibly with compilation and/or installation. The executable codes or source codes of the instructions of the software elements may also be downloaded from a remote location.

Those skilled in the art may clearly know from the above embodiments that the present disclosure may be implemented by software with necessary hardware, or by hardware, firmware and the like. Based on such understanding, the embodiments of the present disclosure may be embodied in part in a software form. The computer software may be stored in a readable storage medium such as a floppy disk, a hard disk, an optical disk or a flash memory of the computer. The computer software comprises a series of instructions to make the computer (e.g., a personal computer, a service station or a network terminal) execute the method or a part thereof according to respective embodiment of the present disclosure.

The present disclosure being thus described, it will be obvious that the same may be varied in many ways. Such variations are not to be regarded as a departure from the spirit and scope of the present disclosure, and all such modifications as would be obvious to those skilled in the art are intended to be included within the scope of the following claims.

1. A method applied in an autonomous vehicle, characterized in comprising:
receiving data from a plurality of environment perception sensors on the vehicle and data from a plurality of vehicle motion sensors on the vehicle,
generating control parameters for control devices including an acceleration device, a braking device, and a steering device, based on at least the received data, and
outputting the received data and the generated control parameters to a driver.

2. The method of claim 1, wherein generating the control parameters comprises: generating the control parameters with use of a machine learning technology, based on the received data and map information.

3. The method of claim 1, wherein the control parameters comprise:
an acceleration starting time, an acceleration ending time, and an acceleration for the acceleration device,
a braking starting time, a braking ending time, and an acceleration for the braking device, and
a steering starting time, a steering ending time, and a steering angle for the steering device.

4. The method of claim 1, further comprising:
receiving data from a plurality of position sensors mounted in the control devices, in a case wherein the driver manually drives the vehicle,
comparing the data from the plurality of position sensors with the corresponding control parameters, so as to generate evaluation for the driver's driving skill, and
outputting the evaluation for the driver's driving skill.

5. The method of claim 1, further comprising:
receiving data from a plurality of position sensors mounted in the control devices, in a case wherein the driver manually drives the vehicle,
comparing the data from the plurality of position sensors with the corresponding control parameters, so as to generate suggestions for improving the driver's driving skill, and
outputting the suggestions for improving the driver's driving skill.

6. The method of claim 1, further comprising:
receiving data from a plurality of position sensors mounted in the control devices, in a case wherein the driver manually drives the vehicle,
predicting an upcoming driving situation, based on the data from the plurality of position sensors, the data from the plurality of environment perception sensors, and the data from the plurality of vehicle motion sensors, and
if it is predicted that there is a danger, outputting a warning to the driver, or intervening the driving.

7. The method of claim 1, further comprising:
receiving data from a plurality of driver-monitoring sensors on the vehicle, in a case wherein the driver manually drives the vehicle,
determining whether there is an abnormality, based on the data from the plurality of driver-monitoring sensors, and
if it is determined that there is an abnormality, outputting a warning to the driver, or intervening the driving.

8. The method of claim 1, wherein the outputting comprises: outputting to a display and/or a speaker within the vehicle, or outputting to a mobile communication device of the driver.

9. The method of claim 1, wherein the outputting is achieved in an acoustic manner, in a visual manner and/or in a vibrating manner.

10. The method of claim 1, wherein the environment perception sensors comprise at least one of the following: a laser radar, a millimeter wave radar, a camera, and an ultrasonic sensor, and the vehicle motion sensors comprise at least one of the following: a speed sensor, an angular velocity sensor, an inertial sensor, and a global positioning system.

11. The method of claim 7, wherein the driver-monitoring sensors comprise at least one of the following: a camera, and a bioelectric sensor.

12. An apparatus applied in an autonomous vehicle, comprising: means for performing the method according to claim 1.

13. An apparatus applied in an autonomous vehicle, comprising:
a memory configured to store a series of computer executable instructions; and
a processor configured to execute said series of computer executable instructions,
wherein said series of computer executable instructions, when executed by the processor, cause the processor to:
receive data from a plurality of environment perception sensors on the vehicle and data from a plurality of vehicle motion sensors on the vehicle,
generate control parameters for control devices including an acceleration device, a braking device, and a steering device, based on at least the received data, and
output the received data and the generated control parameters to a driver.

14. A system applied in an autonomous vehicle, comprising:
the apparatus of claim 13;
a display, for outputting an image and/or a video to the driver; and
a speaker, for outputting a sound to the driver.

15. A non-transitory computer readable medium having instructions stored thereon that, when executed by a processor, cause the processor to:
receive data from a plurality of environment perception sensors on the vehicle and data from a plurality of vehicle motion sensors on the vehicle,
generate control parameters for control devices including an acceleration device, a braking device, and a steering device, based on at least the received data, and
output the received data and the generated control parameters to a driver.

16. An autonomous vehicle comprising the apparatus of claim 13.
